(19) United States
(12) Patent Application Publication
(10) Pub. No.: US 2008/0083374 A1
(43) Pub. Date: Apr. 10, 2008

(54) PET CARRIER FOR A VEHICLE

(76) Inventors: Loretta A. Thomas, Placida, FL (US); Ellen Jones, Placida, FL (US)

Correspondence Address: CHRIS A. CASEIRO, VERRILL DANA, LLP, ONE PORTLAND SQUARE, PORTLAND, ME, 04112-0586, US

(21) Appl. No.: 11/539,484

(22) Filed: Oct. 6, 2006

(51) Int. Cl. A01K 29/00

(52) U.S. Cl. 119/28.5

(57) ABSTRACT

A pet carrier which may be stably held within the interior of a vehicle. The carrier includes two hangers separated by one or more reinforcement members, a pet bin member into which a pet may be placed, and a support member. In a preferred use of the carrier, one of the hangers is placeable over the top and back of one seat of a vehicle, such as the driver's seat of the vehicle, and the other hanger is placeable over the top and back of another vehicle seat, such as the front passenger seat of the vehicle, and the support member is contactable with a surface of the vehicle, such as its floor, to stabilize the carrier. The distance between the hangers is selectable to allow the carrier to be stably placed upon seats of varying separation.

### BACKGROUND OF THE INVENTION

1. Field of the Invention

The present invention relates to carrying devices. More particularly, the present invention relates to carrying devices that are capable of carrying pets. Still more particularly, the present invention relates to carrying devices that are capable of being connected to the interior of a vehicle for transporting one or more pets therein.

2. Description of the Prior Art

Many of us enjoy the thrills and rewards associated with being a pet owner. Indeed, most of the activities that we engage in with our pets, such as playing fetch or cuddling, are very gratifying. Not all of the activities that we partake in with our pets, however, are pleasant. In particular, transporting a pet in a vehicle can be frustrating, or worse, dangerous to both the pet and the human occupants of the vehicle. For example, some pet owners are in the habit of allowing their pet to remain unrestrained in a vehicle during a drive. Unfortunately, a pet that is free to roam may through its own volition move about the interior of the vehicle, or, through outside forces, such as sudden braking or swerving of the vehicle, be jostled about the vehicle. This is problematic because such movement of the pet about the vehicle can be distracting to the driver, and therefore dangerous to the vehicle's occupants.

There are existing devices designed to keep a pet localized to a particular area of a vehicle. For example, some pet owners equip the back of their vehicle with a cage or cage-like device which confines the pet to that area of the vehicle. This approach is unsatisfactory because it does not permit the driver of the vehicle, and any front seat passenger, to interact with the animal during the ride. For example, when a pet is confined to the back of a vehicle, the driver cannot easily give the pet a treat or stroke its head when the vehicle is stopped at a stop light or stop sign. This means that any physical interaction with the pet must be postponed until the commute is completed or until the driver stops the vehicle at a location which is safe enough for the driver to exit the vehicle and access the pet. This would be especially unsatisfactory at times when the pet requires immediate attention.

To avoid this particular limitation, some pet owners may choose to use one of the existing devices that are designed to localize a pet to an area of a vehicle within reach of the driver. Each of these existing devices has one or more other significant limitations that render it less than optimal. One of these devices is the pet carrier described in U.S. Pat. No. 5,785,003 issued to Jacobson et al. Specifically, the pet carrier of Jacobson includes a basket for holding a pet which is mountable to only a single seat, such as the front passenger seat. This arrangement is not desirable, however, because the mounted carrier blocks the entire seat, thereby preventing a human from sitting in the seat. Specifically, this is disadvantageous because at times whenever a pet is being transported in the Jacobson carrier in a vehicle along with two human occupants, the driver and a passenger, the passenger must sit in a seat that is in a row removed from the driver. Separation of this kind would be undesirable, for example, when the driver and passenger wish to converse with each other.

Another device which localizes a pet to an area of a vehicle within reach of the driver is the pet carrier of Selph described in U.S. Pat. No. 5,044,321. The Selph carrier is a non-rigid pouch, such as one made of a textile material, which may be suspended between two seats of a vehicle. One significant limitation of the Selph carrier is that its pouch restricts the freedom of the pet it carries to move and change body positions. In fact, a pet in the Selph pouch is described as being “effectively rendered immobile.” In just a short time, such immobilization of a pet would cause that pet to develop painful cramps and otherwise cause it to experience discomfort. Therefore, the Selph pouch is not optimally useful for long drives. Another significant limitation of the Selph carrier is that it needlessly endangers the pet it carries. This is true because a pet being carried in the pouch likely would be ejected from the pouch whenever the vehicle makes a sudden stop.

The vehicle console pet seat of O'Donnell, which is described in U.S. Patent Application Publication 2005/0284415, is another example of a device that localizes a pet to an area of a vehicle within reach of the driver. Specifically, the console pet seat of O'Donnell includes a basket for holding a pet. The basket rests upon and is supported by a console located between the driver's seat and front passenger's seat of a vehicle, such as a console that is factory-installed in some vehicles. The O'Donnell pet seat is not optimally arranged because it would not be suitable for use in vehicles that do not contain a console between the driver's seat and front passenger's seat, and therefore is limited to being used in only vehicles having such a console having a uniform flat surface large enough to support the pet seat. The O'Donnell pet seat further is not optimally arranged because it would block or restrict access to the console. Therefore, in some cases, a user of the O'Donnell device would be forced to take the time-consuming steps of unloading a pet from the pet seat and removing the pet seat from the console before being able to access the console. In some vehicles, the O'Donnell pet seat may even block or restrict access to the gear shifting mechanism of the vehicle.

Another limitation of the O'Donnell pet seat is that it is cumbersome to install in a vehicle. This is true because it includes a plurality of straps, all of which must be securely fastened to various parts of a vehicle for proper installation of the seat. Further, while the task of fastening and tightening these straps is cumbersome to an able-bodied individual, it would pose a very difficult, if not impossible, challenge to less able-bodied individuals, such as those having arthritis, for example.

What is needed therefore is a pet carrier for a vehicle that enables the pet to be carried between the driver and front seat passenger in a vehicle without obstructing the vehicle's console or the seating area of either the driver or the front seat passenger. The needed pet carrying device should further be adjustable to span a variety of distances, as the distance between the front passenger seat and driver's seat varies from vehicle-to-vehicle. Further, what is needed is a pet carrier that can be installed in a vehicle quickly and easily and without the need of an existing support member, such as a central console.

### SUMMARY OF THE INVENTION

It is an object of the present invention to provide a device for carrying a pet in a vehicle. It is another object of the present invention to provide a device that will allow the pet to be carried specifically in the front of the vehicle, such as to allow interaction between the driver and the pet and to allow the driver to best monitor and interact with the pet. It is yet another object of the present invention to provide a device for carrying a pet in the front of a vehicle which, by being reversibly connectable to, and containable between, two seats, does not obstruct the vehicle's console or the seating area of either the driver or the front seat passenger. It is yet another object of the present invention to provide a device for carrying a pet in the front of a vehicle which may be adjusted to be substantially containable between seats of various separation.

These and other objects are achieved by the present invention, which is an improved pet carrier for a vehicle. The pet carrier includes an adjustable holding member and a pet bin member for placing a pet therein. The adjustable holding member may be placed over the tops of the backs of two car seats, such as the front passenger seat and the driver's seat. When the holding member is placed over the tops of the backs of the seats, the pet bin member extends substantially horizontally away from the seatbacks and toward the front of the vehicle such that it is essentially parallel to the seat bottoms. By largely spanning the gap between the two seats and minimally overlapping with the seats, the pet carrier of the present invention allows both a driver and human passenger to occupy the seats comfortably while keeping the pet near the driver.

The pet carrier of the present invention further includes at least one adjustable support member for stabilizing the bin member. The support member extends from the bin member to contact a surface of the vehicle, such as the vehicle's floor. The support member includes a base to establish adequate contact.

The holding member may be adjusted such that it is capable of spanning a variety of distances. Therefore, although the distance between seats can vary greatly from vehicle-to-vehicle, the adjustability of the holding member enables the pet carrier of the present invention to be used in a variety of vehicles.

The details of one or more examples related to the invention are set forth in the accompanying drawings and the description below. Other features, objects, and advantages of the invention will be apparent from the following description and accompanying drawings, and the appended claims.

### BRIEF DESCRIPTION OF THE DRAWINGS

FIG. 1 is a perspective view of a pet carrier of the present invention.

FIG. 2 is a first front view showing the pet carrier of the present invention reversibly secured to, and substantially positioned between, two seats of a vehicle.

FIG. 3 is a second front view showing the pet carrier of the present invention reversibly secured to, and substantially positioned between, two seats of a vehicle spaced farther apart than the two seats shown in FIG. 2.

FIG. 4 is a side view of a portion of a support member of the pet carrier of the present invention reversibly positioned on a floor console of a vehicle.

FIG. 5 is a perspective view of a frame of the bin member of FIGS. 1-3 shown without a soft material cover.

FIG. 6 is a top view of a soft material of the bin member of FIGS. 1-3 shown separated from the frame.

FIG. 7A is a perspective view of the soft material of the bin member of FIGS. 1-3 shown as being partially reversibly connected to the frame.

FIG. 7B is a magnified side sectional view of the soft material of the bin member of FIGS. 1-3 shown as being reversibly connected to the frame by a fastener.

FIG. 8 is a perspective view of a rigid support member and a pocket of the soft material of the bin member of FIGS. 1-3 showing the base member separated from the frame.

FIG. 9A is a perspective view of an embodiment of the bin member of the present invention.

FIG. 9B is a side view of an embodiment of the bin member of FIG. 9A and connected canopy of the present invention.

FIG. 10A is a front view of a pair of reinforcement members, a first hanger, and a second hanger of the present invention.

FIG. 10B is a front view of a first slat with depressible button usable with any of the reinforcement member, the first hanger, and the second hanger of the present invention.

FIG. 10C is a front view of a second slat with a plurality of openings usable with the first slat of FIG. 10B of the reinforcement member, the first hanger, and the second hanger of the present invention.

FIG. 10D is a side view of the first slat of FIG. 10B and the second slat of FIG. 10C reversibly connected to each other.

### DETAILED DESCRIPTION OF THE PREFERRED EMBODIMENT

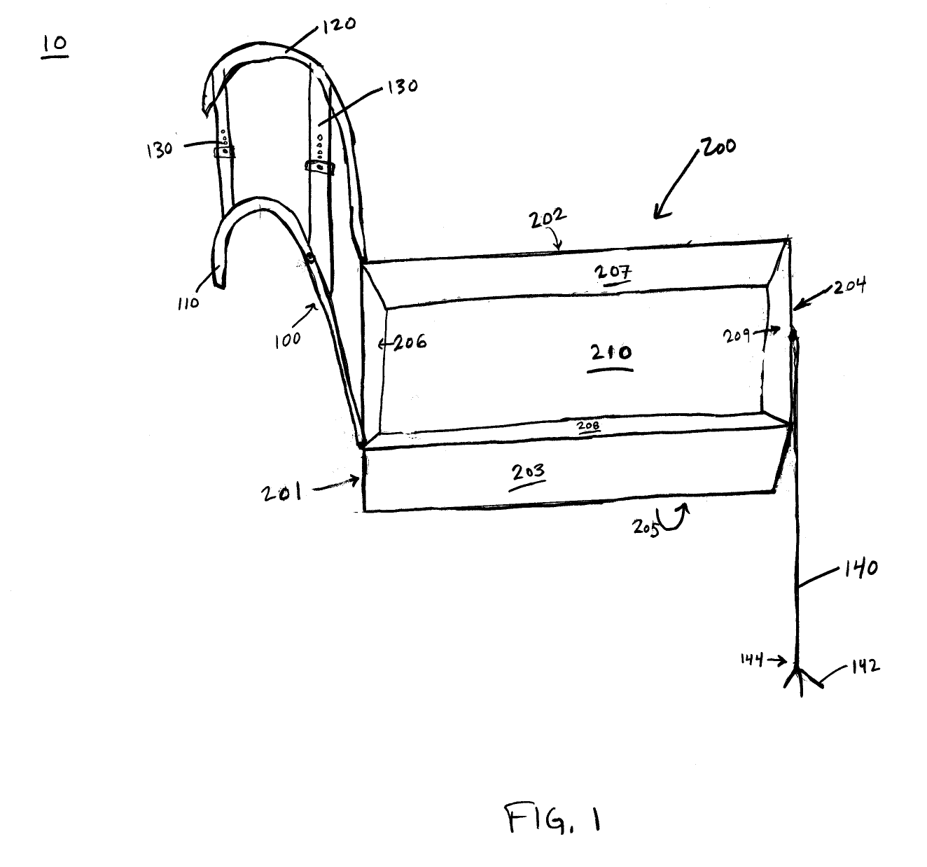

As illustrated in FIGS. 1-3, the present invention is a pet carrier 10 for use in a vehicle. The pet carrier 10 includes an adjustable holding member 100 and a pet bin member 200 connectable to the holding member 100. The holding member 100 includes a first hanger 110 and a second hanger 120. The first hanger 110 and second hanger 120 are separated from each other by one or more reinforcement members 130 connectable to both the first hanger 110 and the second hanger 120. The reinforcement member or members 130 provide stability to the holding member 100. The lengths of the reinforcement members 130 are adjustable. Specifically, these lengths may be adjusted for the purpose of varying the distance between the first hanger 110 and the second hanger 120. One or more support members 140 are connectable to the bin member 200. The support member 140 includes a base 142 at end 144 thereof.

The bin member 200 is sufficiently large enough to hold one or more relatively small pets of various sizes. The bin member 200 is shown in all figures herein as an open rectangular box arrangement. However, it is to be understood that the bin member 200 is not limited to being an open rectangular box. The bin member 200 instead may be, for example, circular or ovular shaped.

The first hanger 110 and the second hanger 120 are connectable to the bin member 200 at first outer surface 201. It is to be understood, however, that the first hanger 110 and the second hanger 120 are not limited to being connectable to first surface 201. The second hanger 120 may be connectable directly to the bin member 200 at second outer surface 202, and the first hanger 110 may be connectable directly to bin member 200 at third outer surface 203, for example. Those skilled in the art would recognize that other arrangements are possible.

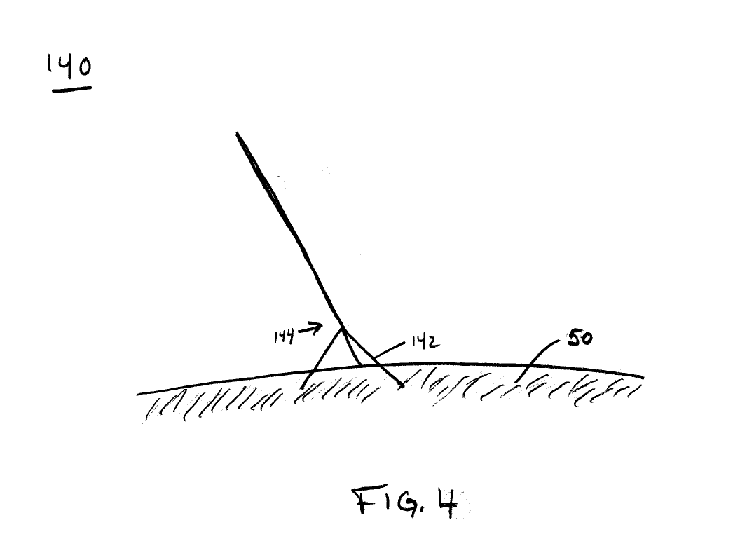

The support member 140 is connectable to the bin member 200 at fourth outer surface 204 as shown in FIGS. 1-3. While the support member 140 is preferably connectable to fourth outer surface 204, it is to be understood that the support member 140 may be connectable to another part of the bin member 200. The length of the support member 140 is adjustable and the member 140 may be pivoted into a variety of positions. The base 142 of the support member 140 may be a tripod, such as the tripod shown in FIG. 4, for example. As another example, the base 142 may be a suction cup. The base 142, however, is not limited to being a tripod or suction cup.

The first hanger 110, second hanger 120, reinforcement members 130, and support member 140 may be made of a metallic or non-metallic material. The material used to make these components should be of sufficient strength for the purpose of the carrier 10, but also should be of minimal weight to keep the overall weight of the carrier 10 low. An exemplary material from which these components may be made, therefore, is, but is not limited to being, aluminum.

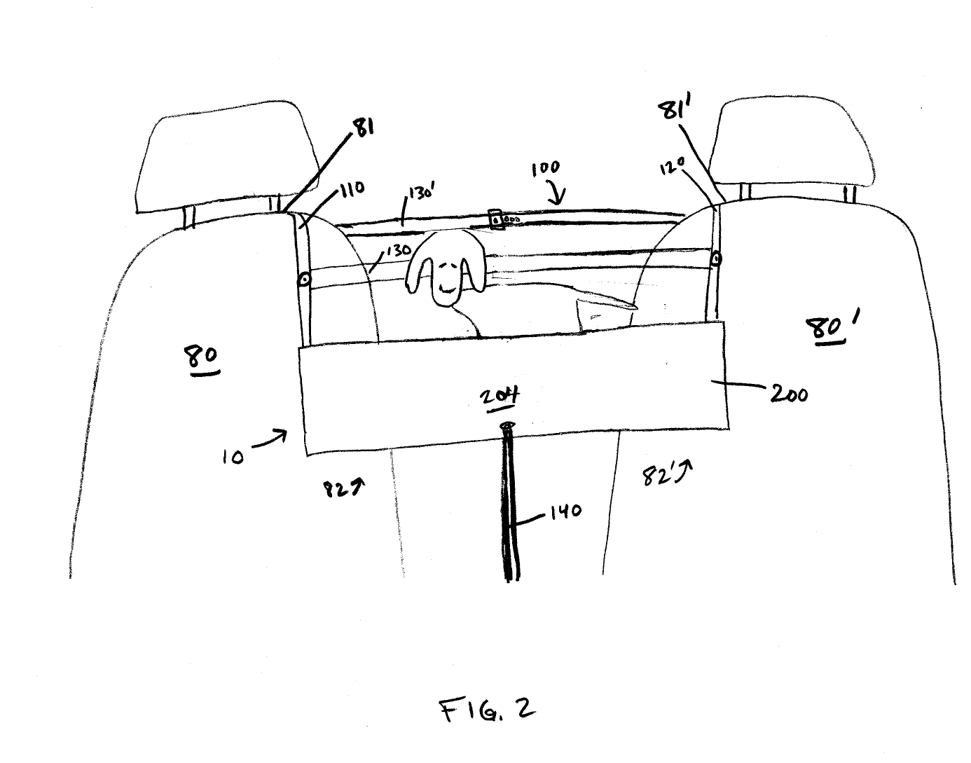

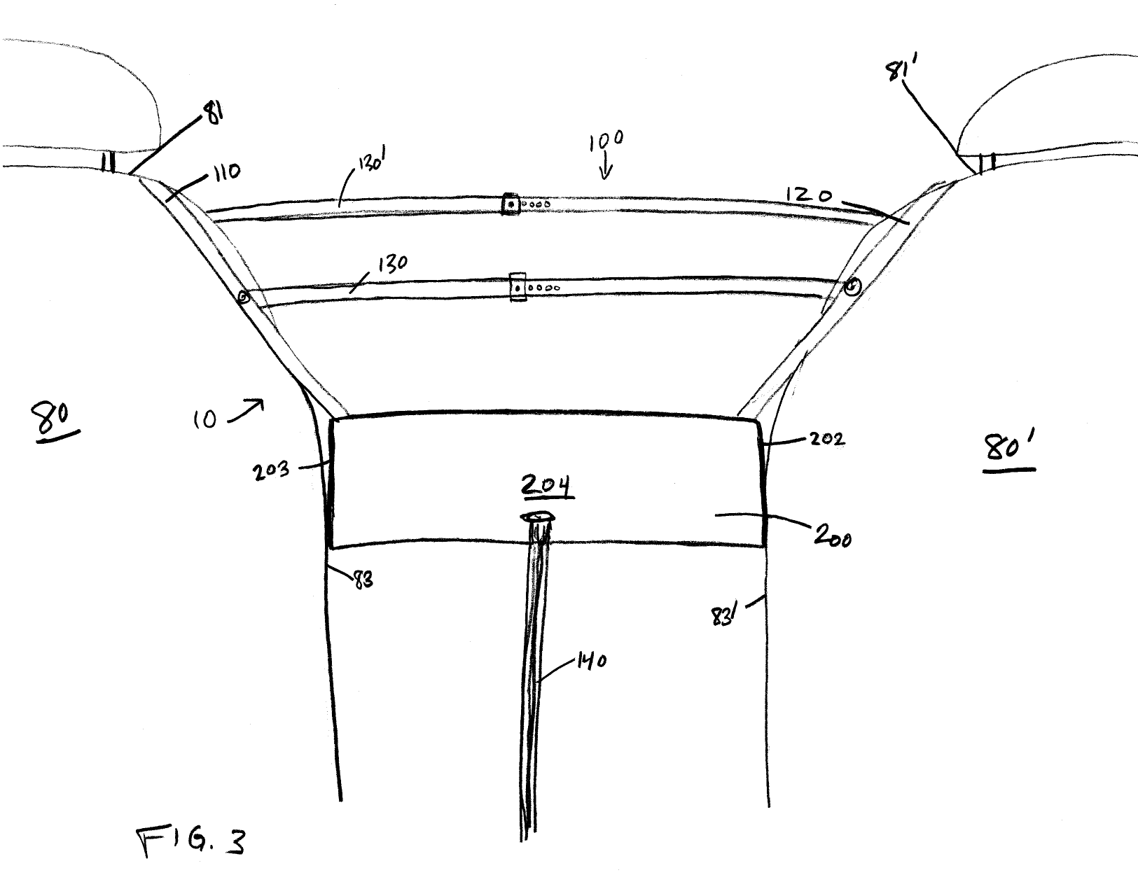

To stably hold the pet carrier 10 to the interior of a vehicle, the first hanger 110 and second hanger 120 are placeable over the tops 81 and 81′ of the backs of seats 80 and 80′ of the vehicle as shown in FIGS. 2 and 3. When placed over the tops of the backs of the seats 80 and 80′ of the vehicle, second surface 224 of the bin member 200 may partially overlap and rest against seat 80 at its front surface 82, and third surface 226 of the bin member 200 may partially overlap and rest against seat 80′ at its front surface 82′, as shown in FIG. 2. Alternatively, when placed over the tops of the backs of the two seats 80 and 80′ of the vehicle, second surface 224 of the bin member 200 may contact side surface 82 of seat 80, and third surface 226 of the bin member 200 may contact side surface 82′ of seat 80′, as shown in FIG. 3.

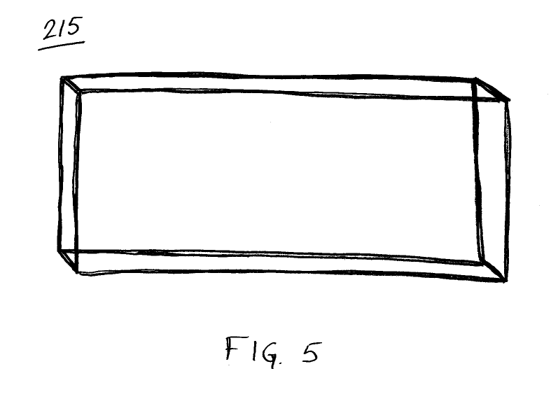

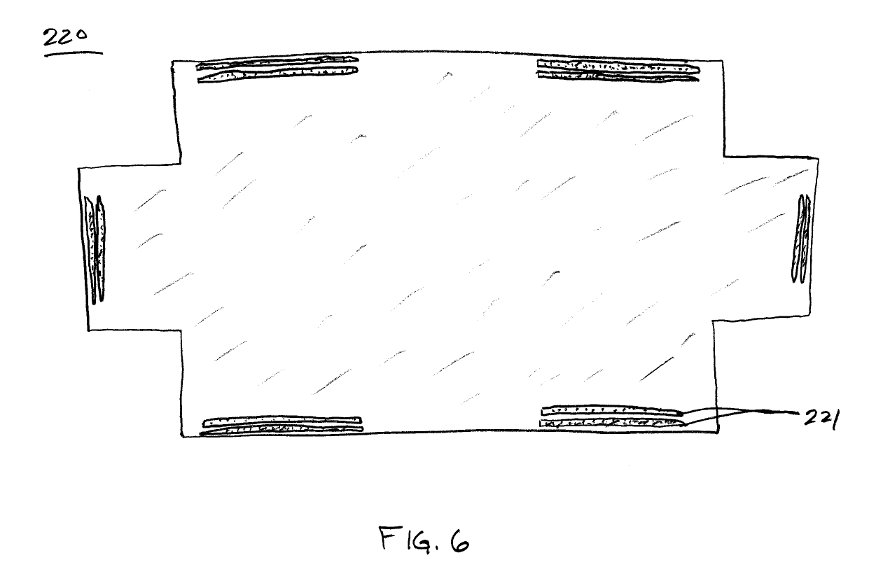

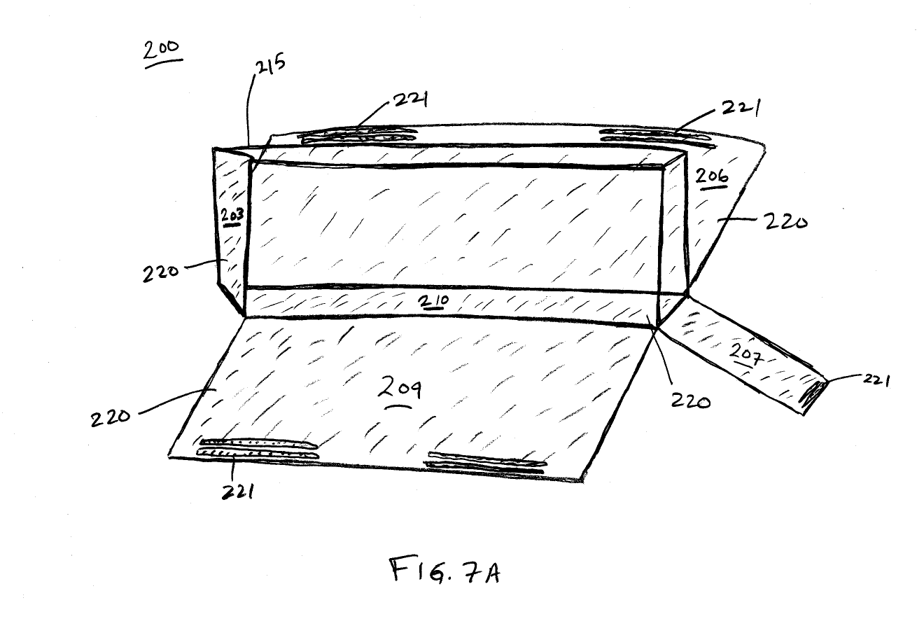

In addition to first outer surface 201, second outer surface 202, third outer surface 203, and fourth outer surface 204, the bin member 200 has a fifth outer surface 205, a first inner surface 206, a second inner surface 207, a third inner surface 208, a fourth inner surface 209, and a fifth inner surface 210. The bin member 200 is partially formed by a collapsible frame 215, which is shown in its uncollapsed state in FIG. 5. The frame 215 is made of metal, plastic or another rigid material. A soft material 220, which is shown in FIG. 6, is reversibly connectable to the frame 215, and includes a plurality of fasteners 221 for this purpose. As shown in FIG. 6, which shows only the soft material 220 of the preferred embodiment, the plurality of fasteners 221 are hook-and-loop fasteners, such as Velcro® fasteners. As shown in FIGS. 7A and 7B, a single fastener 221 reversibly secures part of the soft material 220 to the frame 215. When the soft material 220 is fully connected to the frame 215, the soft material 220 is substantially taut. Further, the soft material 220 is removable from the frame 215. It may be desirable to remove the soft material 220 from the frame 215, for example, when the soft material 220 requires cleaning. When the soft material 220 is removed from the frame 215, the frame 215 is collapsible for easy storage.

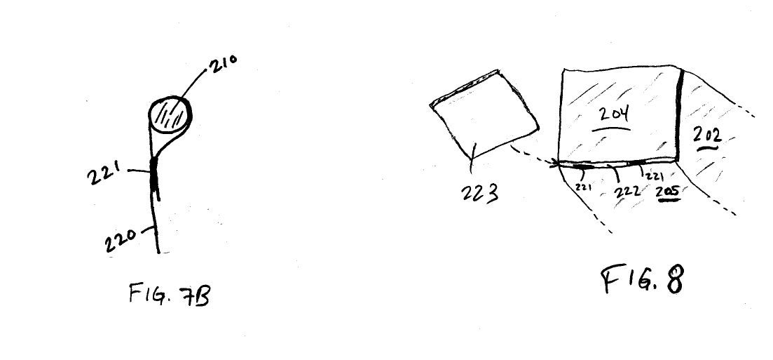

As shown in FIG. 8, the soft material 220 includes an optional closable pocket 222 at the junction between what is fifth outer surface 205 and fourth outer surface 204 of the bin member 200 when the soft material 220 is connected to the frame 215 to form the bin member 200. The pocket 222 includes the fastener 221 for reversibly closing the pocket 222. The pocket 222 is designed to receive and hold a rigid support member 223. When the support member 223 is contained in the pocket 222, the support member 223 provides a rigid support surface for any pet in the bin member 200. The support member 223 may be made of, but is not limited to being made of, masonite.

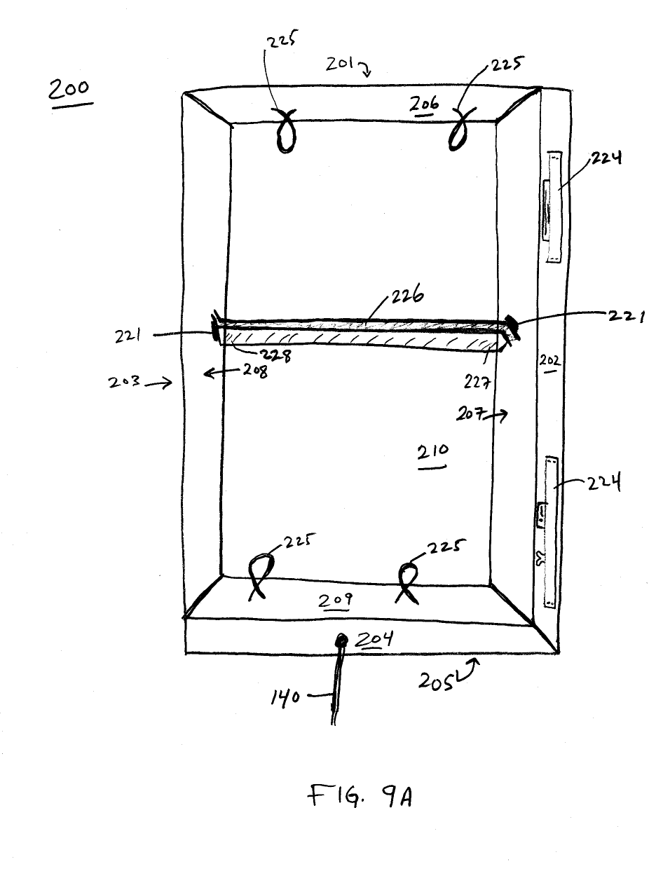

As shown in FIGS. 9A and 9B, the soft material 220 may include one or more side pouches 224, preferably located on bin member 200 outer surfaces 201, 202, 203, 204, and/or 205, but not limited thereto, for carrying items such as veterinary documents, chew toys, and pet treats.

The bin member 200 further includes one or more elastic loops 225, preferably connectable to inner side wall 206, 207, 208, and/or 209, but not limited thereto. The elastic loops 225 may be used, for example, for reversibly securing a pet's harness, and therefore the pet, to the bin member 200. The bin member 200 also includes an optional bin member divider 226 which may be reversibly connected to the inside of the bin member 200 by using the fastener 221. The fastener 221 may be located at either or both of ends 227 and 228 of the divider 226. Ends 227 and 228 of the divider 226 are shown in FIG. 9A reversibly connectable to inner side walls 207 and 208 of the bin member 200. Alternatively, the divider 226 may be rotated 90 degrees such that ends 227 and 228 are reversibly connected to bin side walls 206 and 209 instead. Including the optional divider 226 may be desirable, for example, when two pets are to be carried in the carrier 10, such as to separate the two pets from each other.

In an alternative embodiment, the entire bin member 200 is made of a contiguous rigid material, such as plastic or metal. When the entire bin member 200 is made of a rigid material, all or part of the rigid material optionally may be covered with a cushioned material, such as lamb's wool, to cushion and comfort the pet.

As shown in FIG. 9B, the bin member 200 further includes an optional canopy 230, which partially or entirely covers the bin member 200. The canopy 230 may be, but need not be, collapsible. Further, the canopy 230 may be raised or it may be flat. The canopy 230 may be used, for example, to shield a pet from the sun or air conditioning in the vehicle.

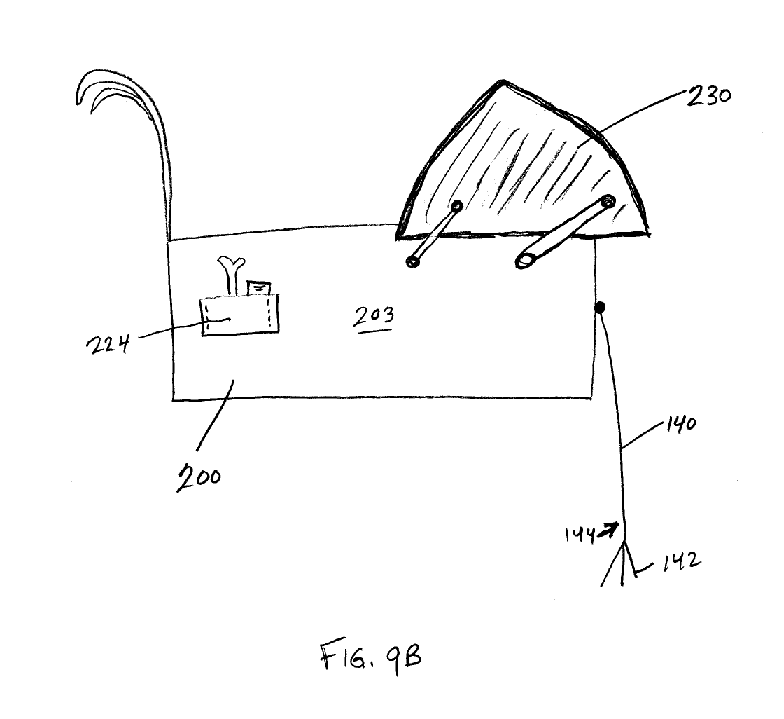

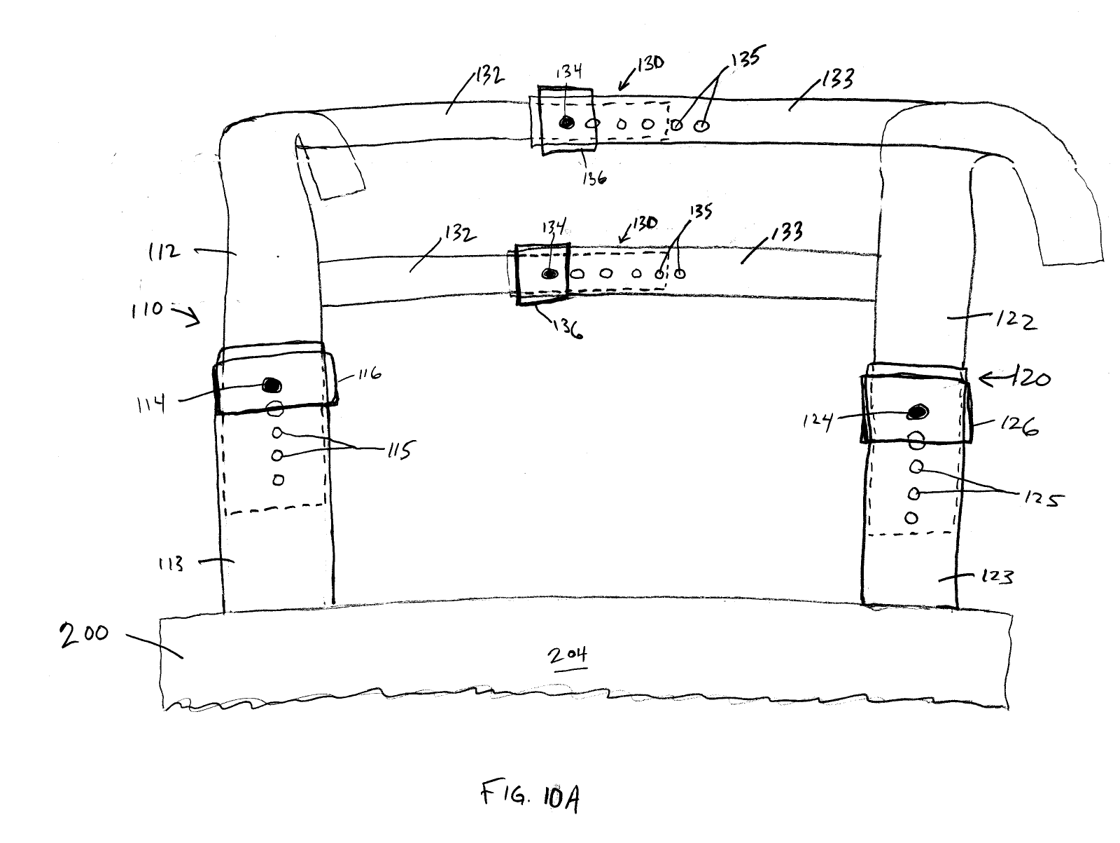

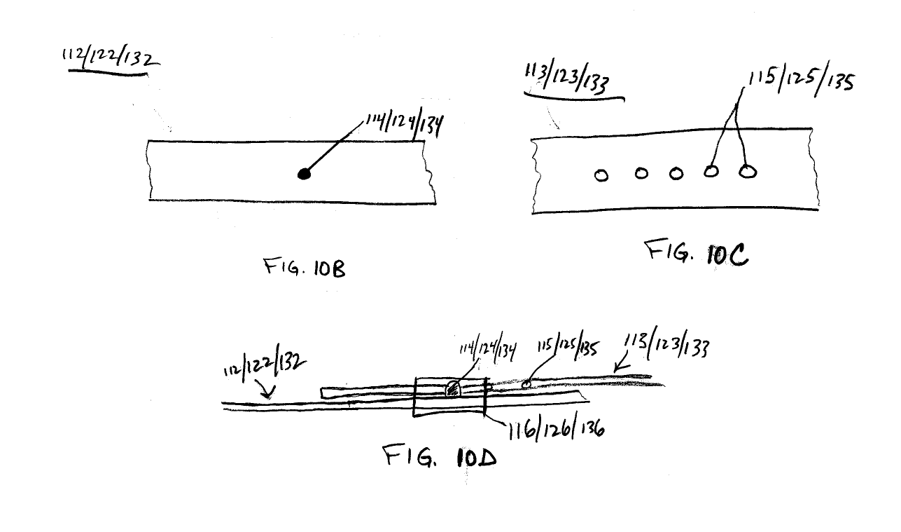

As shown in FIG. 10A-10D, each of the reinforcement members 130 includes two slats: a first slat 132 and a second slat 133, which second slat 133 overlaps the first slat 132. The first slat 132 includes a depressible button 134 and the second slat 133 includes a plurality of openings 135. The button 134 is securely and reversibly placeable into any of the openings 135. The slats 132 and 133 are slidably containable within a slat holding device 136. The holding device 136 may be, but is not limited to being, a buckle. It is to be understood that the pet carrier 10 may include a single reinforcement member 130, which single reinforcement member 130 may be adjustable.

The lengths of the first hanger 110 and the second hanger 120 are optionally adjustable. For example, as shown in FIGS. 10A-10D, each of the first hanger 110 and second hanger 120 may be arranged to include a first slat 112/122 having a depressible button 114/124, a second slat 113/123 having a plurality of openings 115/125 into which the button 114/124 may be reversibly and securely fitted, and a slat holding device 116/126 for slidably holding the first slat 112/122 and second slat 113/123 together. That is, the first hanger 110 and the second hanger 120 may be adjustable in the same manner that the reinforcement members 130 are adjustable.

Since it is expected that the distance between the two seats 80 and 80′ will vary from vehicle-to-vehicle, the spacing between the hangers 110/120 may need to be adjusted prior to placing the carrier 10 over the two seats 80 and 80′. Specifically, the extent of this hanger adjustment may be selected by moving the first hanger 110 and second hanger 120 toward or away from each other. As an example of how the spacing between the first hanger 110 and second hanger 120 may be adjusted, the reinforcement members 130 may be adjusted by changing the position of the button 134 of the first slat 132 in the openings 135 of the second slat 133. In this arrangement, the button 134 fits securely into any of the openings 135. When the button 134 is depressed to release it from retention within a particular one of the openings 135, the second slat 133 may be freely slid over the button 134 and the first slat 132. Sliding of the second slat 133 over the first slat 132 effectively changes the distance between the first hanger 110 and the second hanger 120. When the desired spacing between the hangers 110 and 120 is approximately achieved, the button 134 is released into the opening 135 of the second slat 133 to which the button 134 is most proximate.

Further, the position of the bin member 200 in relation to the tops 81 and 81′ of the seats 80 and 80′ may optionally be adjusted. Specifically, this distance may be changed by adjusting the lengths of the first hanger 110 and the second hanger 120. As an example of how the distance between the bin member 200 and seat tops 81 and 81′ may be adjusted, the first hanger 110 and second hanger 120 may be adjusted by using the button 114/124 of the first slat 112/122 and the openings 115/125 of the second slat 113/123. In this arrangement, the button 114/124 fits securely into each of the openings 115/125. When the button 114/124 is depressed to release it from retention within a particular one of the openings 115/125, the second slat 113/123 may be freely slid over the button 114/124 and the first slat 112/122. Sliding of the second slat 113/123 over the first slat 112/122 effectively changes the height of the hanger 110/120. When the desired heights of the hangers 110 and 120 are approximately achieved, the button 114/124 is released such that it slides into the opening 115/125 of the second slat 113/123 to which the button 114/124 is most proximate.

When the hangers 110/120 of the pet carrier 10 are placed over the tops of the backs of seats 80 and 80′ of a vehicle, the carrier 10 may be stabilized by using the support member 140. In FIG. 4, the tripod base 142 of the support member 140 is shown as contacting a vehicle's floor surface 50. Pressure exerted on the bin member 200 by the contact made between the floor surface 50 and the bin member 200, through the support member 140, stably holds the carrier 10 to, or between, the seats 80 and 80′ (not shown in FIG. 4), and therefore within the vehicle. Alternatively, the support member 140 may be operated to stabilize the bin member 200 on a vehicle console. For example, the support member 142 may include a suction cup base 142 reversibly affixable to the console.

While the present invention has been described as being placeable over the tops of the backs of two seats of a vehicle, it is to be understood that it is not limited to being used in this manner. Therefore, the present invention may be placeable over the top of the back of a single seat of a vehicle, such as the vehicle's backseat, for example.

While the present invention has been described with particular reference to certain embodiments of the pet carrier, it is to be understood that it includes all reasonable equivalents thereof as defined by the following appended claims.

1. A pet carrier for a vehicle, comprising:
a. a bin member;
b. a first hanger connectable to the bin member;
c. a second hanger connectable to the bin member and spaced from the first hanger;
d. at least one reinforcement member of adjustable length directly connected to the first hanger and the second hanger, such that the at least one reinforcement member joins the first hanger and the second hanger together, wherein the spacing between the first hanger and the second hanger may be selected by adjusting the length of the at least one reinforcement member; and
e. a support member having a first end and a second end, wherein the first end is connectable to the bin member and the second end is arranged for stabilizing engagement with a surface of the vehicle.

2. The pet carrier of claim 1 wherein the lengths of the first hanger and the second hanger are selectable.

3. The pet carrier of claim 1 wherein each of the first hanger and the second hanger includes:
a. a first slat having a depressible button; and
b. a second slat having a plurality of openings, wherein the depressible button may be securely and reversibly held within any one of the plurality of openings.

4. The pet carrier of claim 1 wherein the at least one reinforcement member includes:
a. a first slat having a depressible button; and
b. a second slat having a plurality of openings, wherein the depressible button may be securely and reversibly held within any one of the plurality of openings.

5. The pet carrier of claim 1 wherein the bin member includes a frame associated with a soft material, and the soft material includes at least one fastener for holding the soft material onto the frame.

6. The pet carrier of claim 5 wherein the soft material is selected from the group consisting of canvas and wool.

7. The pet carrier of claim 5 wherein the at least one fastener of the soft material is a hook-and-loop fastener.

8. The pet carrier of claim 5 wherein the soft material includes a closable pocket.

9. The pet carrier of claim 8 wherein the pet carrier includes a rigid flat member which is reversibly insertable into the closable pocket of the soft material.

10. The pet carrier of claim 1 wherein the bin member includes at least one pouch.

11. The pet carrier of claim 1 wherein the bin member includes at least one hook.

12. The pet carrier of claim 11 wherein the at least one hook is made of an elastic material.

13. The pet carrier of claim 1 wherein the bin member further includes at least one divider member.

14. The pet carrier of claim 1 further including a canopy connectable to the bin member.

15. The pet carrier of claim 1 wherein the second end of the support member includes a tripod for stabilizing engagement with a surface of the vehicle.
